(19) United States
(12) Patent Application Publication
(10) Pub. No.: US 2004/0059821 A1
(43) Pub. Date: Mar. 25, 2004

(54) Method and system for a point to point protocol-bridge operating mode in network communication system

(76) Inventors: Jian Tang, Fremont, CA (US); Ta-Sheng Lin, San Jose, CA (US); Xinzhang Ma, Fremont, CA (US); Guangjie Yang, Fremont, CA (US)

Correspondence Address: Seong-Kun Oh, Esq., JACKSON & CO., L.L.P., 6114 La Salle Ave., Ste 507, Oakland, CA, 94611-2802, US

(21) Appl. No.: 10/253,329

(22) Filed: Sep. 24, 2002

(51) Int. Cl. G06F 15/16

(52) U.S. Cl. 709/228

(57) ABSTRACT

Method and system for providing a PPP-Bridge operating mode in a data communication system is disclosed. Upon receiving a PPP connect request from a user terminal at the LAN interface in a dial-up mode of application, or through the use of pre-configuration in a leased-line mode of application, the access device establishes a PPP session with a remote PPP server via its WAN interface. Once the PPP session is established, the access device receives a public IP address from the remote PPP server and relays the received IP address via DHCP to the corresponding user terminal. To the data network, it appears as though the user terminal is operating with the public IP address from the remote PPP server, even though the PPP session is established between the access device and the remote PPP server. This method and system supports multiple PPP sessions through the use of user profiles stored on the access device. Each user profile stores the public IP address of a PPP session corresponding to its respective user terminal.

### BACKGROUND OF THE INVENTION

The present invention relates to a method and system for providing a data network. More specifically, the present invention relates to a method and system for a point-to-point protocol—Bridge (PPP-Bridge) operating mode in a data communication system.

The recent surge in broadband Internet access from consumers and businesses has propelled significant development and research in establishing faster access to the Internet. One example includes the xDSL (Digital Subscriber Line) type connection using an access device such as a DSL modem, which connects to the traditional twisted copper pair telephone lines to deliver high speed data transmission substantially faster than the traditional 56K dial-up type modems. Other examples include cable modem connection of a user terminal, such as a personal computer, to the Internet via a routing (or access) device (i.e., a cable modem) which is connected over the cable line traditionally installed at homes and business sites to deliver cable television signals. Other broadband-connections are presently available such as high speed wireless connections using satellite connections.

Briefly mentioned above, DSL is a digitized data communication technology that delivers high speed, bi-directional Internet access over the traditional telephone lines. DSL technology allows the user to share the existing phone line with their DSL line, providing an “always-on” Internet connection that supports data transmission speed of up to 52 Mbps depending upon the distance between the customer site and the telephone company's Central Office (CO). More particularly, the DSL technology incorporates connecting a DSL modem at the customer premise, for example, connected to a personal computer at the user's home and the telephone line. At the other end of the DSL connection, the DSL-enabling switch equipment at the telephone company's Central Office site aggregates or consolidates all of the customer DSL lines and routes the data traffic onto a backbone network for distribution to networks such as the Internet Service Provider (ISP), or corporate data networks.

For establishing the broadband communication connection, typically, Point-to-Point Protocol (PPP) is used, which is a serial communication protocol that allows Internet Protocol (IP) network connections over dial-up or leased lines. A dial-up line includes a connection which requires the user to initiate the communication connection session, such as by initiating the session manager for 56K modem dial-up process. The leased line connections, on the other hand, typically include communication connection sessions that are “always-on” upon powering on of the Internet accessing device, such as a broadband modem and the like.

More specifically, the PPP provides a standard procedure for transporting multi-protocol datagrams over point-to-point links. As such, the PPP includes three main components (i.e., sub-protocols)-Link Control Protocol (LCP), Challenge Handshake Authentication Protocol/PPP Authentication Protocols (CHAP/PAP), and Internet Protocol Control Protocol (IPCP). Typically, these PPP sub-protocols perform the data-link connection control, authentication, and IP address negotiation for each PPP session.

In this manner, PPP is used to permit a user terminal to establish data connection for transmit and receive over a data network such as the Internet, corporate data networks and the like using a telephone line and a high-speed modem or router (such as, for example, a DSL modem or a cable modem). Indeed, PPP makes high speed data access easier to use for end users and more seamless to integrate into the existing data infrastructure for carriers and ISPs. It should be noted that depending upon the format and media, the PPP may be referred to as PPPoA or PPPoE, the former referring to PPP over ATM (Asynchronous Transfer Mode), and the latter, referring to PPP over Ethernet.

Typically, broadband data networks employ an access device or an access terminal to establish PPP connection to data networks, such as, corporate data network or the Internet. More specifically, the access device has the capability to initiate a PPP session (either a PPPoE or a PPPoA session). The access device may be configured to operate either in Network Address Translation (NAT) router mode or in a pure (or transparent) bridge mode.

When configured to operate in the NAT router mode, the access device couples to user terminals via a Local Area Network (LAN) and to a remote server via a Wide Area Network (WAN). The remote server in turn connects to the Internet. After the PPP connection is established, the access device has a connection to the remote server and to the Internet. The access device receives a public IP address from the ISP and assigns it to the WAN side of the access device. This public address is visible to the Internet. Using the Dynamic Host Control Protocol (DHCP), the access device assigns private IP addresses to respective user terminals coupled to the same LAN interface. The private IP addresses are seen only on the LAN side, and are not visible to the Internet.

For each of the user terminals to successfully communicate with the data network, address translation must occur between the private IP addresses respectively assigned to each of the user terminals, and the public IP address corresponding to the PPP session received from the ISP. The NAT router mode of the access device is typically configured to provide the address translation between the private IP addresses and the public IP address such that the user terminals may successfully connect to the desired data network.

By assigning private IP addresses to the user terminals coupled to the same LAN, only one public IP address is required to connect these user terminals to the data network. However, a drawback of this setup is that many application programs installed on the user terminals are not designed to operate with a translation service such as the NAT router function in the access device. Rather, these application programs expect public IP addresses to be allocated for use exclusively for their particular application. Thus, these application programs store IP addresses in areas that normal NAT access device cannot locate, which may result in improper or unsuccessful translation. When the IP address translation does not successfully occur for all of the IP addresses, those application programs running on the user terminals may return unexpected errors, often crashing the system at the user terminals or rendering themselves inoperable with the NAT router mode of the access device.

In the case where the access device is operating in the pure bridge mode, the access device is configured such that it does not get involved in the PPP session or the IP address allocation. In this scenario, a user terminal must use a Public IP address in order to access the Internet. If no PPP or other authentication is installed and used on the user terminal, it would potentially compromise network security and raise data integrity issues related to account management. Additionally, if the user terminals coupled to the access device include PPP client programs installed therein to initiate the PPP session, which raises issues related to compatibility among the various operating environments of the various user terminals in the LAN. Moreover, recently ISPs have tended to move away from this type of network deployment due to the concern that a bridged data network does not expand and can be managed effectively. Thus, it can be seen that when the access device is configured to operate in the transparent bridge mode, concerns and issues often arise related to data security, compatibility with respect to the various installed PPP client programs, and network expansion. Indeed, while the access device may be configured to operate in one of several operating modes which includes network access translation (NAT) router mode and a transparent bridge mode, these modes each have their subsequent shortcomings during operation as discussed above.

### SUMMARY OF THE INVENTION

In view of the foregoing, the present invention includes a method and system for providing a PPP-Bridge operating mode in a data network. More specifically, the PPP-Bridge operating mode in accordance with the various embodiments of the present invention is configured to relay the public IP address received from the remote server to the user terminal using dynamic host control protocol (DHCP). In particular, upon receiving a PPP connect request from a user terminal at the LAN interface in a dial-up mode of application, or through the use of pre-configuration in a leased-line mode of application, the access device establishes a PPP session with a remote PPP server via its WAN interface. Once the PPP session is established, the access device receives a public IP address from the remote PPP server and relays the received IP address via DHCP to the corresponding user terminal.

To the data network, it appears as though the user terminal is operating with the public IP address from the remote PPP server, even though the PPP session is established between the access device and the remote PPP server. This method and system supports multiple PPP sessions by employing user profiles stored on the access device. Each user profile in the access device stores the public IP address of a PPP session corresponding to its respective user terminal. Also, references made to PPP herein is intended to include both PPPoA or PPPoE discussed above.

A system for providing a PPP-Bridge mode for a data network in accordance with one embodiment includes a remote PPP server operatively coupled to a data network, an access device operatively coupled to the remote server and configured to receive a public Internet protocol (IP) address from the remote PPP server, and a user terminal operatively coupled to the access device, the user terminal configured to receive the public IP address from the access device via DHCP and to communicate with the data network.

The user terminal may be operatively coupled with the access device through one of a dial-up and a leased-line application modes. Further, the user terminal may be configured to transmit a connect request to the access device in a dial-up application mode, in which case, the access device is configured to initiate a PPP session to said remote PPP server upon receiving said connect request. Additionally, the PPP session may include a PPP username and a PPP password that are provided by either the user terminal or the access device.

Moreover, the access device may be configured to automatically initiate a PPP session upon completing a power-up sequence when the user terminal is operatively coupled to the access device through the leased-line application mode.

Furthermore, the access device may further include a memory for storing a user profile, where the user profile includes one or more of a public IP address and a media access control (MAC) address corresponding to the user terminal. Also, the user profile may be configured to store a PPP username, a PPP password, and a mode of application for the user terminal.

In one aspect, the user terminal may include one of a personal computer, a laptop computer, a handheld computing device, and a wireless computer device, where the remote server may include an Internet Service Provider, and the data network includes the Internet.

Additionally, the access device is operatively coupled to the remote server by a wide area network, while the user terminal is operatively coupled to the access device by a local area network. The local area network may include one or more of a USB connection, an ethernet connection, and a wireless connection.

In a further aspect, the access device may be configured to relay the public IP address received from the remote PPP server to the user terminal via DHCP. The access device may include one or more of a Digital Subscriber Line (DSL) modem, a cable modem, and a wireless network modem, and include a LAN interface to operatively couple to the user terminal, and a wide area network interface to operatively couple to the remote PPP server.

In yet a further aspect, the access device may be configured to operate in one of a plurality of operating modes, said plurality of operating modes including a network access translation (NAT) router mode, a transparent bridge mode, and a PPP-Bridge mode.

A method of providing a PPP-Bridge operating mode for a data network in accordance with another embodiment includes operatively coupling a remote PPP server to a data network, operatively coupling an access device to a remote PPP server, the access device configured to receive a public IP address from the remote server, and operatively coupling a user terminal to the access device to receive public IP addresses from the access device, and to operatively connect with the data network.

The method may further include the step of detecting a PPP connect request, and initiating a corresponding PPP session negotiation with the remote PPP server.

Further, the method may also include the step of relaying the public IP address to the user terminal via DHCP.

In yet still another embodiment, the method may further include the step of configuring the access device to operate in one of a plurality of operating modes, the plurality of operating modes including a network address translation (NAT) router mode, a transparent bridge mode, and a PPP-Bridge mode.

A method of yet another embodiment includes initiating a PPP connection, negotiating the PPP session and receiving a public IP address corresponding to the negotiated PPP session, relaying the received public IP address via DHCP to the corresponding user terminal.

The method may further include the step of storing the received public IP address corresponding to the negotiated PPP session.

Furthermore, the method may also include detecting a PPP session terminate signal, terminating the negotiated PPP session, and reassigning private IP address to the corresponding user terminal after the PPP session is terminated.

A program storage device readable by a machine, tangibly embodying a program of instructions executable by the machine to perform a method for providing a PPP-Bridge operating mode for a data network in accordance with still another embodiment includes initiating a point-to-point protocol connection, negotiating the PPP session and receiving a public Internet protocol (IP) address corresponding to the negotiated PPP session, and relaying the received public IP address via dynamic host control protocol to the corresponding user terminal.

These and other features and advantages of the present invention will be understood upon consideration of the following detailed description of the invention and the accompanying drawings.

### BRIEF DESCRIPTION OF THE DRAWING

FIG. 1 illustrates the overall data communication system for practicing one embodiment of the present invention;

FIG. 2 illustrates a screen shot of the user interface in a dial up mode application, displayable at the user terminal for establishing a PPP session in the data communication system of FIG. 1;

FIG. 3 is a flowchart illustrating one embodiment of the operation of the data communication system of FIG. 1;

FIG. 4 is a flowchart illustrating one embodiment of establishing a PPP session in a dial up mode application at the user terminal in the data communication system of FIG. 1;

FIG. 5 is a flowchart illustrating one embodiment of the operation procedures of the access device of the data communication system shown in FIG. 1;

FIG. 6 is a flowchart illustrating another embodiment of the operation procedures of the access device serving multiple user terminals in system shown in FIG. 1;

FIG. 7 is a flowchart illustrating a further embodiment of the operation procedures of the access device with PPP session termination of the data communication system shown in FIG. 1; and

FIG. 8 is a flowchart illustrating yet another embodiment of the operation procedures of the access device serving multiple user terminals and with PPP session termination.

### DETAILED DESCRIPTION

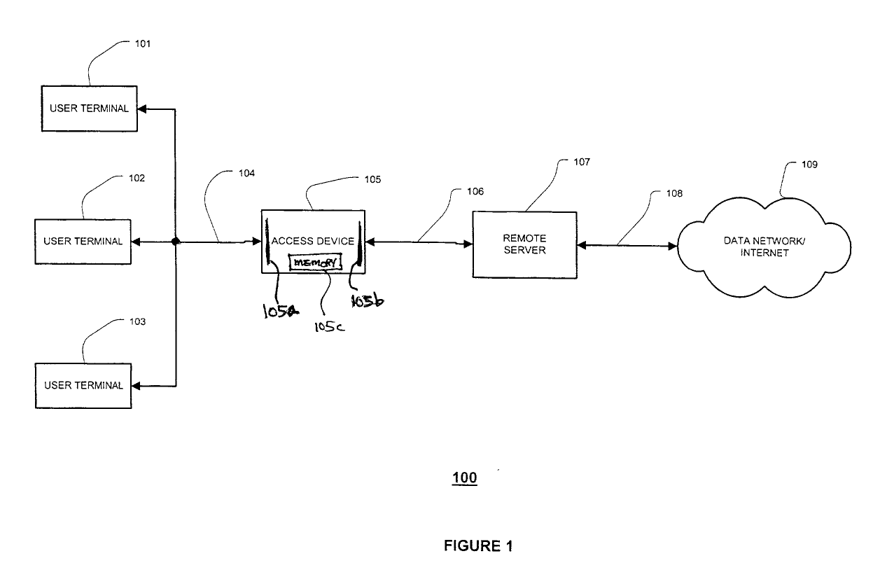

FIG. 1 illustrates the overall data communication system for practicing one embodiment of the present invention. Referring to the Figure, the data communication system 100 includes a plurality of user terminals 101, 102, 103, each operatively coupled to an access device 105 via a LAN connection 104. The access device 105 includes a LAN interface 105a to operatively couple each of the user terminals 101, 102, 103 to the access device 105. The three user terminals 101, 102, 103 are shown in FIG. 1 for purposes of illustration only. The present invention is not intended to be limited to a local area network including three user terminals. Within the scope of the present invention, more or fewer user terminals may be operatively coupled to the access device 105 via the LAN connection 104.

The access device 105 is further configured to include a wide area network (WAN) interface 105b to operatively couple to a remote server 107 through a WAN connection 106. The remote server 107 may include a PPP server located at the ISP for access to the Internet, or a corporate PPP server for access to the corporate data network.

Referring again to FIG. 1, the remote server 107 is configured to connect to the data network 109 via a communication link 108. As discussed above, the data network may include the Internet or a corporate data network.

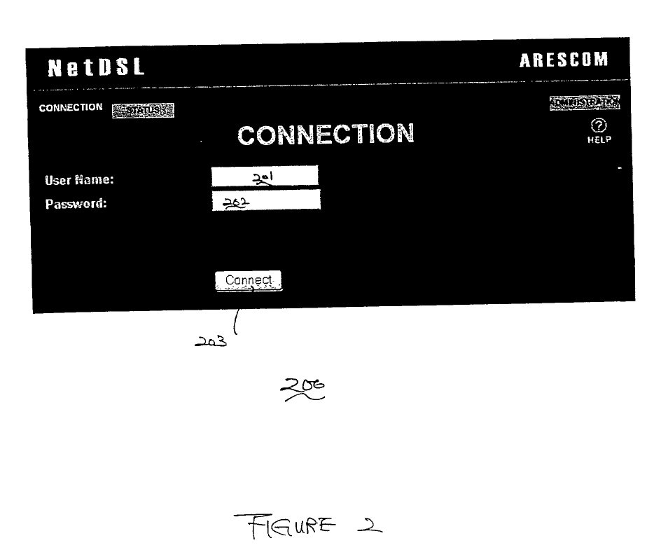

As discussed in further detail below, the data communication system 100 may be configured to operate in either a dial-up or a leased line mode of application to connect the user terminals 101, 102, 103 to the access device 105 and the access device 105 to the data network 109. In the case of the dial-up mode of application, a valid PPP username and password is transmitted from the user terminal using a user interface discussed in further detail in conjunction with FIG. 2. Upon transmission of the username and password to the access device 105, the access device 105 is configured to negotiate with the remote server 107 to establish a PPP session. Alternatively, in a leased-line mode of application, the PPP username and password are pre-configured and stored in the access device 105. Additionally, a user terminal is pre-configured and its hardware ID (e.g. MAC address) is saved in the access device 105. As a result, this PPP session is reserved for this user terminal only. Thus, after the power-up sequence of the access device 105 is completed, the PPP session will automatically be initiated for the user terminals.

After the PPP session is established and the public IP address relayed to the user terminal (e.g. 101), the user terminal which has initiated the PPP session in dial-up mode or has reserved the PPP session in leased-line mode, now has a connection to the remote server 107 and is able to access the data network 109 to transmit or receive data. In the case where multiple PPP sessions are established, the access device 105 is capable of tracking which data flow should be forwarded to which respective PPP session. All parameters (e.g. username, password, hardware ID, and PPP session ID) of each PPP session are stored in their corresponding user profile (e.g., user profile table) in a memory 105c of the access device 105.

More specifically, once the PPP session is established, the access device 105 is configured to receive a public IP address from the remote server 107, and through DHCP, relay the public IP address to the respective user terminal 101 corresponding to the PPP session. In the case of multiple PPP sessions, each PPP session goes through the same process to relay the public IP address of the session to its associated user terminal. In such situation, the access device 105 is configured to track which public IP address is assigned to which user terminal.

As discussed above, the public IP address received from the remote server 107 is assigned to the corresponding one of the user terminals 101-103 by the access device 105 using DHCP. The user terminal sends a DHCP request periodically. The access device 105 has a built-in DHCP server. When PPP session is established, the DHCP server relays the public IP address received from remote server 107 to the user terminal. Otherwise, the DHCP server delivers a private IP address. In the case of multiple PPP connections, each PPP session performs the same steps to relay the public IP address of the PPP session to the associated user terminal, and the access device 105 is configured to keep track of the various IP addresses assigned to the respective corresponding user terminals 101, 102, 103 with a user profile table (including PPP username, password, hardware ID, PPP session ID, among others) of the memory 105c.

FIG. 2 illustrates a screen shot 200 of the user interface in accordance with one embodiment of the present invention in a dial-up mode of application, and is displayable at the user terminal 101 for establishing a PPP session in the data communication system of FIG. 1. Referring to the Figure, the screen shot 200 of the user interface includes, among others, a PPP username field 201 and a PPP password field 202 into which the user may input the appropriate username and password for the respective PPP session using an input device (not shown), such as a keyboard at the user terminal 101.

Also shown in FIG. 2 is a connect button 203 which is configured to transmit the user input PPP username and password. The connect button 203 can be activated by operating, for example, an input device (not shown) such as a computer mouse (not shown).

Various types of user interface utilities may be used to configure the access device 105 with the PPP parameters (i.e., the PPP username and PPP password). In the dial-up mode of application discussed above, the user interface may also be configured to transmit a PPP connect request. More specifically, the user interface may include web based devices, PC-based application programs for Windows® based operating system, and Macintosh®-based application programs for Macintosh® operating system, and telnet-based devices, and directly-attached console devices, among others.

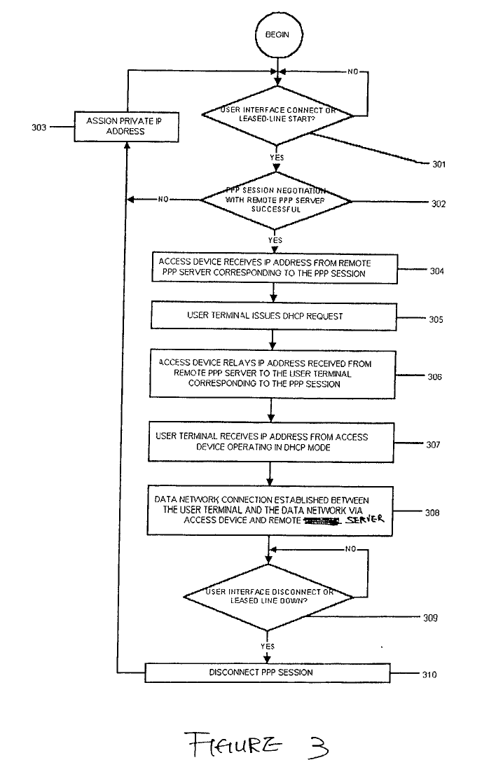

FIG. 3 is a flowchart illustrating one embodiment of the operation of the data communication system of FIG. 1. Referring to FIG. 3, at step 301, it is first determined whether a PPP connect request has been started either through a user interface (a screen shot of which is illustrated in FIG. 2) based dial-up connection, or a leased-line connection for automatic PPP session starts upon power up of the access device 105 (FIG. 1).

If it is determined at step 301 that a PPP connect request has been received by the access device 105 (FIG. 1), then at step 302, the embedded PPP client component in the access device 105 is configured to negotiate the corresponding PPP session with the remote server 107 (FIG. 1) via the WAN connection 106 (FIG. 1). On the other hand, if the negotiation is not successful at step 302, then at step 303 the access device 105 assigns a the private IP address to the user terminal 101. The procedure then returns to the beginning and awaits the detection of another PPP connect request at step 301.

After successful PPP session negotiation with the remote PPP server 107 at step 302, the access device 105 receives a public IP address from the remote server 107 at step 304. It should be noted that the PPP session described herein includes either a PPPoE session or a PPPoA session. Referring back to the Figure, at step 305, the user terminal 101 issues a DHCP request to the access device 105, and at step 306, the access device 105 relays the public IP address received from the remote server 107 to the user terminal 101 corresponding to the PPP session via DHCP reply over the LAN connection 104 (FIG. 1).

At step 307 the user terminal 101 receives the public IP address from the access device 105 operating in DHCP mode. Then, at step 308, a data network connection is established between the user terminal 101 and the data network 109 (FIG. 1) via the access device 105 and the remote server 107, thus allowing the user terminal 101 to gain access to the data network 109.

Thereafter at step 309, the user terminal LAN connection to the access device 105 is monitored to detect when the user terminal 101 has transmitted a request to terminate the PPP session, or when the WAN connection 106 to the access device 105 is disconnected. If there is such a disconnect or line down detection, at step 310, the PPP session corresponding to the user terminal 101 is disconnected, while the access device 105 assigns a private IP address to the disconnected user terminal 101 at step 303, and the procedure returns to step 301. On the other hand, if there is no such detection at step 309, the connection at step 308 between the user terminal 101 and the data network 109 is monitored at step 309 again for the detection of a disconnect or line down.

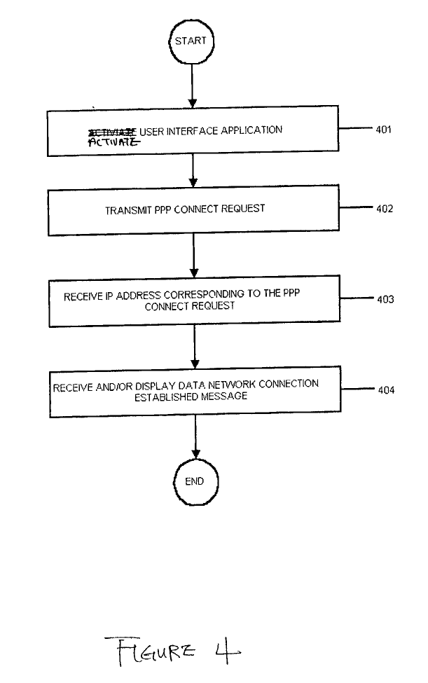

FIG. 4 is a flowchart illustrating the process of establishing a PPP session in a dial-up mode of application at the user terminal 101 in the data communication system of FIG. 1 in accordance with one embodiment of the present invention. For purposes of clarity, FIG. 4 is discussed in conjunction with FIG. 2. At step 401 of FIG. 4, the user terminal 101 initiates the user interface application, and a PPP connect request is submitted at step 402. For example, referring to the screen shot 200 of the user interface of FIG. 2, the PPP connect request may be submitted by operating the submit input button 204 using, for example, an input device (not shown) coupled to the user terminal 101, such as a computer mouse or a keyboard. Thereafter at step 403 of FIG. 4, the user terminal 101 receives an IP address from the access device 105 (FIG. 1) corresponding to the PPP session, and at step 404, in the user interface a notification message is displayed at the user terminal 101 indicating that the connection to the data network 109 has been established successfully.

Alternatively, in leased-line mode of application, PPP username and password and hardware ID are pre-configured in the access device 105. Access device 105 then initiates a PPP session automatically upon completing power-up sequence.

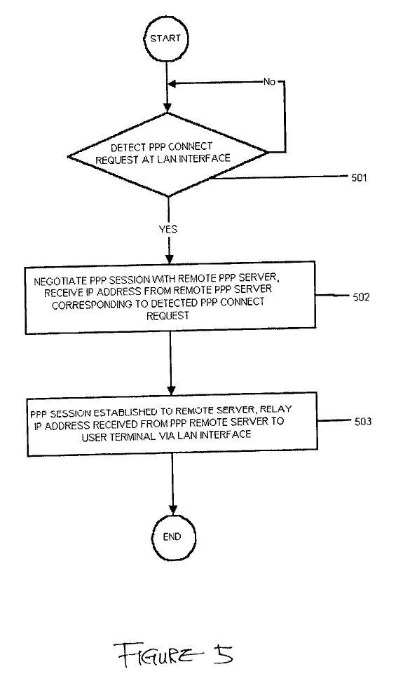

FIG. 5 is a flowchart illustrating the operation procedures of the access device 105 of the data communication system 100 shown in FIG. 1 in accordance with one embodiment of the present invention. At step 501, the access device 105 determines whether a PPP connect request is received from the user terminal 101 at the LAN interface 105a (FIG. 1) which is operatively coupled to the LAN connection 104 (FIG. 1).

If at step 501 it is determined that a PPP connect request is received by the access device 105, then at step 502, the access device 105 negotiates with the remote server 107, and upon successfully negotiating the PPP session with the remote server 107, the access device 105 receives a public IP address from the remote server 107 corresponding to the PPP connect request received from the user terminal 101. Thereafter at step 503, the access device 105 relays the public 1P address received from the remote server 107 to the user terminal 101 that provided the PPP connect request to the access device 105.

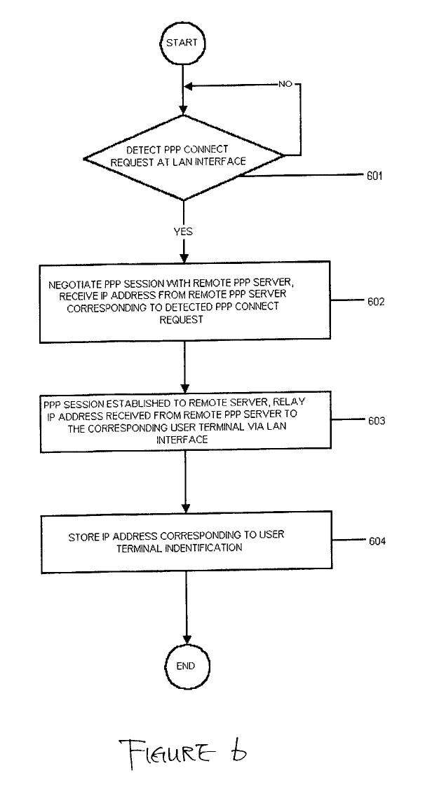

FIG. 6 is a flowchart illustrating the operation procedures of the access device 105 of the data communication system 100 shown in FIG. 1 in accordance with another embodiment of the present invention including multiple PPP sessions. Referring to the Figure, it can be seen that steps 601 through 603 substantially correspond to steps 501 through 503 of the operation procedures shown in FIG. 5, respectively, and thus, the description of these steps are omitted herein.

Referring to FIG. 6, the operation procedures of the access device 105 further includes the step of storing the public IP address received from the remote server 107 in the user profile table of memory 105c of the access device 105 as illustrated at step 604. Indeed, each public IP address received corresponds to a respective PPP session for the user terminal 101 to which the public IP address was relayed. Thus, by storing the public IP address of the PPP sessions received from the remote server 107, the access device 105 is configured to keep track of the various IP addresses for the respective PPP sessions corresponding to the user terminals 101-103 in the local area network which are configured to access the data network 109 in the data communication system 100 (FIG. 1) simultaneously. This approach substantially ensures avoiding system conflicts.

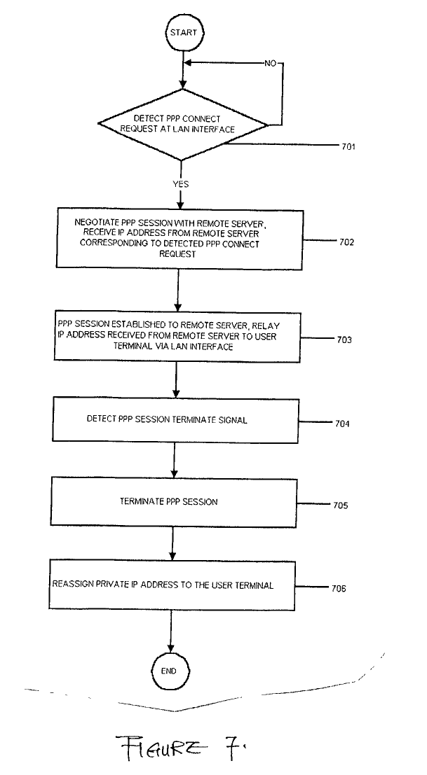

FIG. 7 is a flowchart illustrating a further embodiment of the operation procedures of the access device with PPP session termination of the data communication system shown in FIG. 1 in accordance with a further embodiment of the present invention. Referring to the Figure, it can be seen that steps 701 through 703 substantially correspond to steps 501 through 503 of the operation procedures shown in FIG. 5, respectively, and thus, the description of these steps are omitted herein.

Referring to FIG. 7, the operation procedures of the access device 105 further includes the step of, after relaying the IP address received from the remote server 107 to the user terminal 101 corresponding to the PPP session, detecting a PPP session terminate signal by the access device 105, as illustrated in step 704. Upon detecting the PPP session terminate signal, at step 705 the access device 105 terminates the PPP session corresponding to the detected PPP session terminate signal. In one aspect, the PPP session terminate signal may correspond to a PPP session terminate request input by a user at the user terminal 101. Alternatively, the PPP session terminate signal may correspond to a faulty WAN connection 106 between the remote PPP server 107 and the access device 105. After the PPP session is disconnected at step 705, the access device 105 reassigns a private IP address to the corresponding user terminal at step 706.

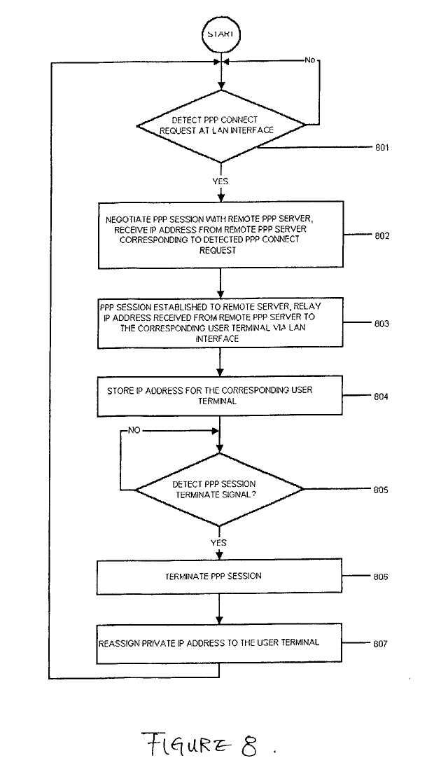

FIG. 8 is a flowchart illustrating yet another embodiment of the operation procedures of the access device serving multiple user terminals and with PPP session termination in accordance with yet a further embodiment of the present invention. Referring to the Figure, it can be seen that steps 801 through 803 substantially correspond to steps 501 through 503 of the operation procedures shown in FIG. 5, respectively, and thus, the description of these steps are omitted herein.

Referring to FIG. 8, the operation procedures of the access device 105 further includes the step of storing, at step 804, the public IP address received from the remote server 107 at step 803, which corresponds to the PPP session for the user terminal 101 to which the IP address was relayed. Thereafter at step 805, the access device 105 is configured to determine whether a PPP session terminate signal is detected. If it is determined at step 805 that a PPP session terminate signal is not detected, the PPP session is intact and the user terminal is still operatively coupled to the data network. On the other hand, if at step 805 the access device 105 detects a PPP session terminate signal, then at step 806, the corresponding PPP session is terminated. After PPP session is terminated, at step 807 the access device 105 reassigns a private IP address to the corresponding user terminal.

In the manner described above, in accordance with the various embodiments of the present invention, a method and system for providing a PPP-Bridge operating mode in a data communication system is disclosed. Indeed, upon receiving a request for a PPP session from a user terminal 101 at the local area network (LAN) interface 105a, the access device 105, such as a DSL modem configured to support DHCP server function, establishes a corresponding PPP session with the remote server 107 (such as the ISP), via its wide area network (WAN) interface 105b. Once the PPP connection is made and the session established, the access device 105 receives a public IP address of the PPP session from the remote server 107. This public IP address is relayed via DHCP through the LAN interface 105a to the user terminal 101 requesting the PPP session. For multiple PPP sessions, the access device 105 is configured to store the public IP addresses of each PPP session corresponding to the respective user terminals to avoid collision or other compatibility concerns.

The user terminals 101-103 may be connected separately in the local area network by one of a USB connection, an ethernet connection, and a wireless connection. Furthermore, the user terminals 101-103 may be configured to communicate with each other in the local area network without significant potential for device collision, as each user terminal 101-103 receives a separate public IP address from the access device 105 for their respective PPP session.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A system for providing a PPP-Bridge mode for a data network, comprising:
a remote PPP server operatively coupled to a data network;
an access device operatively coupled to the remote server and configured to receive a public Internet protocol (IP) address from the remote PPP server; and
a user terminal operatively coupled to the access device, the user terminal configured to receive the public IP address from the access device via DHCP and to communicate with the data network.

2. The system of claim 1 wherein said user terminal is operatively coupled with the access device through one of a dial-up and a leased-line application modes.

3. The system of claim 2 wherein said user terminal is configured to transmit a connect request to the access device in a dial-up application mode.

4. The system of claim 3 wherein the access device is configured to initiate a PPP session to said remote PPP server upon receiving said connect request.

5. The system of claim 4 wherein the PPP session uses a PPP username and a PPP password that are provided by either the user terminal or the access device.

6. The system of claim 2 wherein the access device is configured to automatically initiate a PPP session upon completing a power-up sequence when the user terminal is operatively coupled to the access device through the leased-line application mode.

7. The system of claim 6 wherein the PPP session uses a PPP username and a PPP password that are provided by either the user terminal or the access device.

8. The system of claim 1 wherein the access device further includes a memory for storing a user profile.

9. The system of claim 8 wherein said user profile includes one or more of a public IP address and a media access control (MAC) address corresponding to the user terminal.

10. The system of claim 9 wherein the user profile is configured to store a PPP username, a PPP password, and a mode of application for the user terminal.

11. The system of claim 1 wherein the user terminal includes one of a personal computer, a laptop computer, a handheld computing device, and a wireless computer device.

12. The system of claim 1 wherein the remote server includes an Internet Service Provider, and the data network includes the Internet.

13. The system of claim 1 wherein the access device is operatively coupled to the remote server by a wide area network.

14. The system of claim 1 wherein the user terminal is operatively coupled to the access device by a local area network.

15. The system of claim 14 wherein the local area network includes one or more of a USB connection, an ethernet connection, and a wireless connection.

16. The system of claim 1 wherein the access device is configured to relay the public IP address received from the remote PPP server to the user terminal via DHCP.

17. The system of claim 1 wherein the access device includes one or more of a Digital Subscriber Line (DSL) modem, a cable modem, and a wireless network modem.

18. The system of claim 1 wherein the access device is configured to operate in one of a plurality of operating modes, said plurality of operating modes including a network access translation (NAT) router mode, a transparent bridge mode, and a PPP-Bridge mode.

19. The system of claim 1 wherein the access device includes a LAN interface to operatively couple to the user terminal, and a wide area network interface to operatively couple to the remote PPP server.

20. A method of providing a PPP-Bridge operating mode for a data network, comprising the steps of:
operatively coupling a remote PPP server to a data network;
operatively coupling an access device to a remote PPP server, the access device configured to receive a public IP address from the remote server; and
operatively coupling a user terminal to the access device to receive public IP addresses from the access device, and to operatively connect with the data network.

21. The method of claim 20 further including the step of detecting a PPP connect request, and initiating a corresponding PPP session negotiation with the remote PPP server.

22. The method of claim 21 further including the step of relaying the public IP address to the user terminal via DHCP.

23. The method of claim 20 further including the step of configuring the access device to operate in one of a plurality of operating modes, the plurality of operating modes including a network address translation (NAT) router mode, a transparent bridge mode, and a PPP-Bridge mode.

24. A method, comprising:
initiating a PPP connection;
negotiating the PPP session and receiving a public IP address corresponding to the negotiated PPP session; and
relaying the received public IP address via DHCP to the corresponding user terminal.

25. The method of claim 24 further including the step of storing the received public IP address corresponding to the negotiated PPP session.

26. The method of claim 24 further including the steps of:
detecting a PPP session terminate signal;
terminating the negotiated PPP session; and
reassigning private IP address to the corresponding user terminal after the PPP session is terminated.

27. A program storage device readable by a machine, tangibly embodying a program of instructions executable by the machine to perform a method for providing a PPP-Bridge operating mode for a data network, the method comprising the steps of:
initiating a point-to-point protocol connection;
negotiating the PPP session and receiving a public Internet protocol (IP) address corresponding to the negotiated PPP session; and
relaying the received public IP address via dynamic host control protocol to the corresponding user terminal.
